(19) United States
(12) Patent Application Publication
(10) Pub. No.: US 2012/0310852 A1
(43) Pub. Date: Dec. 6, 2012

(54) ESTABLISHING AN E-BADGE VIA MOBILE PRE-REGISTRATION FOR A VISITOR MANAGEMENT SYSTEM

(75) Inventors: Muthuvel Ramalingamoorthy, Madurai (IN); Sivakumar Balakrishnan, Madurai (IN); Nandakumar Dhandapani, Madurai (IN)

(73) Assignee: Honeywell International Inc., Morristown, NJ (US)

(21) Appl. No.: 13/151,580

(22) Filed: Jun. 2, 2011

(51) Int. Cl. G06Q 10/00; G01C 21/00

(52) U.S. Cl. 705/323; 705/1.1

(57) ABSTRACT

A system and method for establishing an e-badge via mobile pre-registration for a visitor management system is provided. The method includes receiving a pre-registration request for a future visit to a building, confirming the pre-registration request, and providing an e-badge to a guest mobile device for the future visit to the building.

### FIELD OF INVENTION

The present invention relates generally to visitor management systems. More particularly, the present invention relates to systems and methods for establishing an e-badge via mobile pre-registration for a visitor management system.

### BACKGROUND

In many large buildings and facilities, for example, corporate or manufacturing facilities, security is important. Thus, many large buildings employ visitor management systems to handle guests' check in and check out processes.

For example, in known visitor management systems, when a guest or visitor arrives at a building, he must check in with security. Because physical presence and verification is required, the guest cannot check in with security before arriving at the building. When checking in, the guest must present identification and be confirmed by security and/or by a host who is meeting with the guest. If the host has not confirmed the guest prior to his visit, security may contact the host to separately confirm the guest. After confirmation, security must then issue a temporary access badge to the guest for traversing the building.

When the guest has completed his visit, he must check out with security, and the guest cannot leave the building without checking out. When checking out, the guest must surrender his temporary access badge.

When a person is a repeated guest of a building, for example, a contractor or privileged visitor, the check in and check out process can become tedious and time consuming. Even if a person is not a repeated guest of a building, the check in and check out process can be tedious and time consuming. For example, there may be a line to check in or check out when several guests arrive at a building simultaneously. Further, the guest may experience a wait while security contacts a potential host to confirm the guest.

There is thus a continuing, ongoing need for systems and methods for establishing an e-badge via mobile pre-registration for a visitor management system. Preferably, such systems and methods confirm a guest before guest arrival and provide a temporary access badge directly on a guest's mobile device.

### BRIEF DESCRIPTION OF THE DRAWINGS

FIG. 1 is a flow diagram of a method in accordance with the present invention;

FIG. 2 is a block diagram of a system for carrying out the method of FIG. 1 in accordance with the present invention;

FIG. 3 is a plan view of an exemplary e-badge in accordance with the present invention; and

FIG. 4 is a block diagram of central station in accordance with the present invention.

### DESCRIPTION OF THE PREFERRED EMBODIMENTS

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments of the present invention include systems and methods for establishing an e-badge via mobile pre-registration for a visitor management system. Preferably such systems and methods confirm a guest before guest arrival and provide a temporary access badge directly on a guest's mobile device.

In accordance with the present invention, an application can be provided for a guest of a building to register himself before arrival at the building. The guest can be confirmed before arriving at the building, and when the guest does not know his host, he can provide a host approximation. Accordingly, the guest can avoid potentially long lines for checking in upon arrival.

In embodiments of the present invention, a guest can pre-register his visit to a building using a mobile device. For example, the guest can use his mobile device, which can be, for example, a cell phone or personal digital assistant, such as an iPhone®, Blackberry®, Android®, or any other smartphone known in the art. In some embodiments, the guest's mobile device can pre-register his visit via a web or internet application or via an SMS/GRPS based mobile application.

For example, the guest can enter his personal and visiting information into his mobile device. In some embodiments, the guest can pre-register his visit to a building without the aid of security personnel at the building.

In some embodiments of the present invention, a central station or control unit can manage an appointment database. For example, once a guest submits a pre-registration request, the central station can save a record of the guest and his upcoming appointment in an associated database. Upon initial entry in the database, the guest and his upcoming appointment can be identified as “pending.”

The central station can submit the pending guest and upcoming appointment to a host for authorization. In some embodiments, the central station can submit this information to the host's mobile device or computer, for example, his personal computer. The host can confirm the guest and his upcoming appointment, and, once confirmed, the guest and his upcoming appointment can be identified as “confirmed” in the central station database.

In embodiments of the present invention, a guest can view his status via his mobile device. That is, the guest can check whether he and his upcoming appointment are pending or confirmed.

Once the guest and his upcoming appointment have been confirmed, the guest can be considered “authorized” for the upcoming appointment. Once authorized, the guest can access an e-badge via his mobile device. For example, an e-badge can include a temporary access badge displayed directly on the guest's mobile device. In some embodiments, the e-badge can include a photograph or other visual display of the guest as well as details of the guest's appointment, for example, the time, duration, and host of the appointment.

According to the present invention, an e-badge displayed on a guest's mobile device can include a machine-readable representation of data, for example a barcode that represents information about the guest and his upcoming appointment. When the guest arrives at the building for his scheduled appointment, he can use his e-badge to check in with security rather than requiring a paper access badge. For example, the guest can scan or present the barcode of the e-badge to a check in access point of a visitor management system. The guest can also scan or present the barcode of the e-badge to readers at access points throughout the building in order to open doors associated with those access points.

When a guest is new to a building, he may not know the correct route to traverse within the building to reach his destination. Thus, in embodiments of the present invention, after the guest checks in with security using his e-badge, the guest can access and view a route map on his mobile device. In some embodiments, the route map can show the guest's route from the check in location to the guest's destination within the building.

Upon exiting the building after his scheduled appointment, the guest can use his e-badge to check out with security. In some embodiments of the present invention, upon expiration of the guest's scheduled appointment, the e-badge can be removed from or be made unavailable on the guest's mobile device. In other embodiments, the central station can update the status of the guest and his appointment. That is, the central station can identify the guest and his appointment as “expired” in the central station database. After the guest checks out with security and/or after expiration of the guest's scheduled appointment, a route map can also be removed from or be made unavailable on the guest's mobile device.

As explained above, a guest can submit a pre-registration request for an upcoming appointment. In some embodiments, such a request will only be confirmed when the upcoming appointment is with a host who the guest has previously visited. That is, when a host has approved the guest in connection with a previous appointment, the central station can approve the guest for an upcoming appointment with the same host.

When a guest does not know his host for an upcoming appointment, embodiments of the present invention enable the guest to select “unknown host” when submitting a pre-registration request. In some embodiments, when a guest enters “unknown host,” systems and methods of the present invention can request the purpose of the upcoming appointment from the guest. Then, systems and methods of the present invention can assign a host to the guest for his upcoming appointment based on the purpose of the appointment and based on availability of potential hosts.

Some embodiments of the present invention include a web-based application and user interface that can be supported by a guest's mobile device. The interface can display various interactive pages to a guest for pre-registering an upcoming appointment as described above.

In some embodiments, the web-based user interface according to the present invention can be limited to certain guests of the building. That is, some embodiments of the present invention require a log in and password to access the interface.

After logging in to the user interface, a guest can access a plurality of different interactive pages that gather information from the guest and/or display information to the guest. For example, in a “My Visit” page, a guest can view his past, current and future pre-registered appointments as well as the current status for each of those appointments.

In a “Pre-Registration” page, a guest can submit a new pre-registration request by entering the date and time for the upcoming appointment as well as the host for the upcoming appointment. If the host is unknown, the guest can so indicate.

After a new pre-registration request is submitted, the “My Visit” page can be updated to identify the newly scheduled appointment as “pending.” Similarly, a record of the new pre-registration request can be entered in the central station database and be identified as “pending.”

While the request is pending, the central station can send a request to the host, via the host's mobile device or personal computer, to authorize or decline the visit. Based on the host's response, the status of the upcoming appointment can be updated on both the “My Visit” page of the user interface and in the central station database.

In embodiments of the present invention, a guest can access the “My Visit” page or a “My Badge” page of the user interface to view an e-badge. For example, when an upcoming appointment is “authorized,” a user can select that appointment to view the corresponding e-badge for the appointment. As explained above, an e-badge in accordance with the present invention can include a photo of the guest, the name of the guest, a unique barcode for the appointment, the name of the host, and limitations of the e-badge. For example, the e-badge can indicate the date and time during which the e-badge is valid.

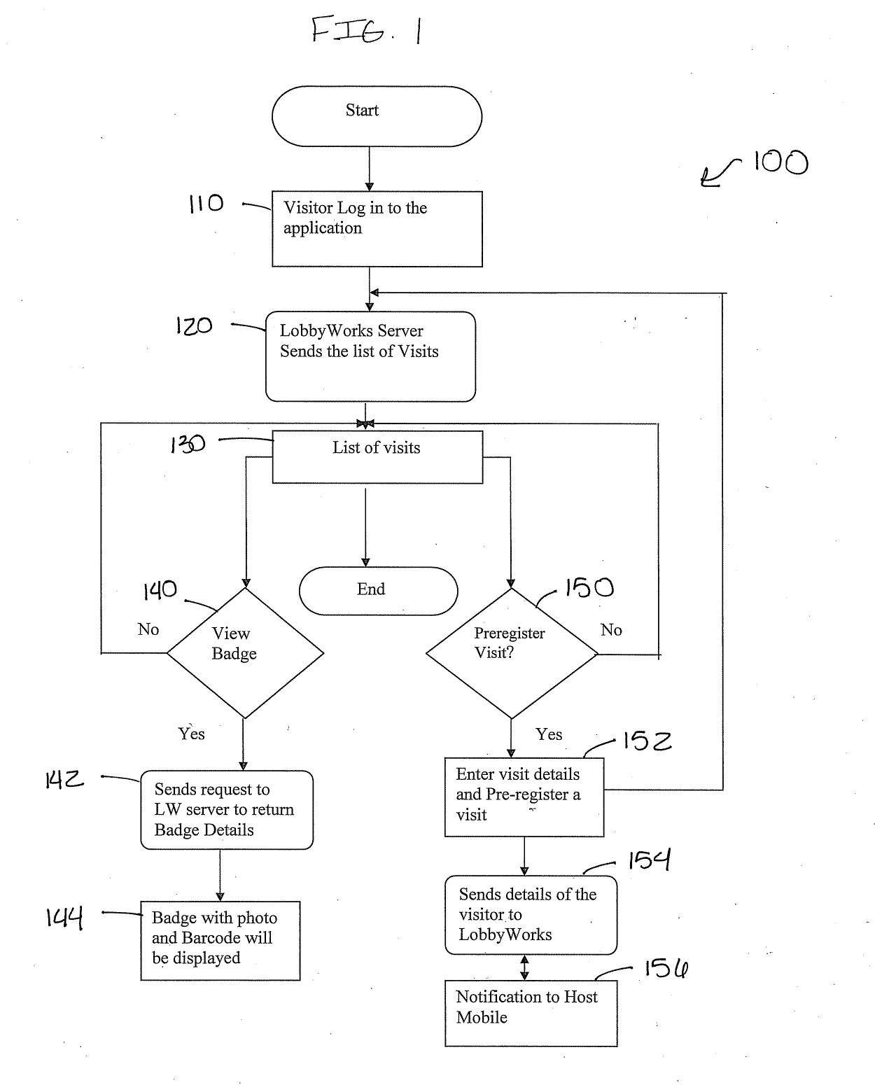

FIG. 1 is a flow diagram of a method 100 in accordance with the present invention. As seen in FIG. 1, a guest can log in to a web-based application and user interface supported by the guest's mobile device as in 110. Then, a central station can access a database and send a list of past, present, and future guest appointments to the user interface as in 120. The user interface can display the guest's past, present, and future appointments as in 130.

The method can then determine if the guest wants to view an e-badge for an authorized appointment as in 140 and/or submit a pre-registration request for a future appointment as in 150. If the guest does not want to do either, then the method can continue displaying the guest's past, present and future appointments as in 130.

When the guest wants to view an e-badge for an authorized appointment as in 140, the method can obtain the details of the appointment from, for example, a server or database, as in 142. Then, the e-badge, including a photo of the guest and a barcode for the appointment, can be displayed as in 144.

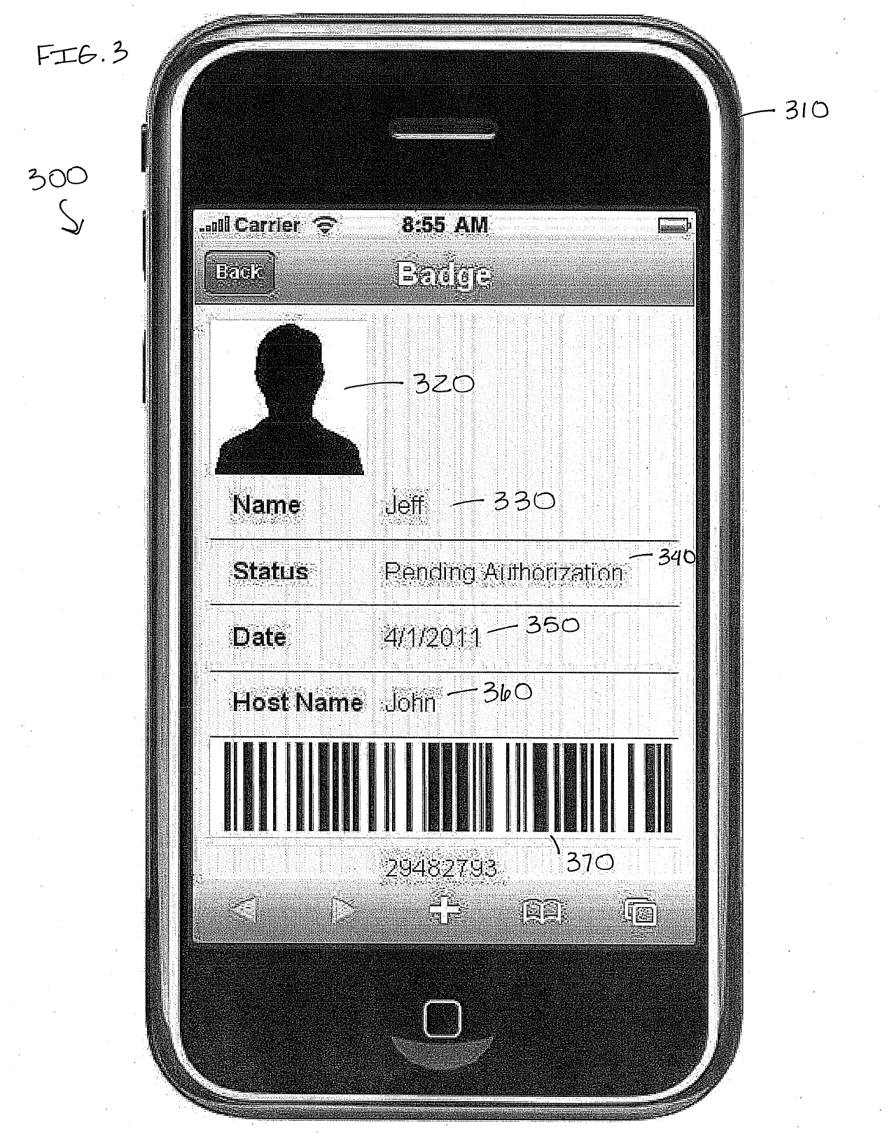

FIG. 3 is a plan view of an exemplary e-badge 300 in accordance with the present invention. As seen in FIG. 3, the e-badge 300 can be displayed on a user's mobile device 310. The e-badge 300 can display a photo of the guest 320, the name of the guest 330, the status of the pre-registration request 340, the date of the appointment 350, the name of the host 360, and a barcode 370 representing information about the guest and his upcoming appointment.

Referring again to FIG. 1, when the guest wants to submit a pre-registration request for a future appointment as in 150, the guest can enter the details of the visit as in 152. Then, the method can send the details of the visit to, for example, a server or database as in 154. The server or database can send a notification of the submitted pre-registration request to the identified host for authorization as in 156.

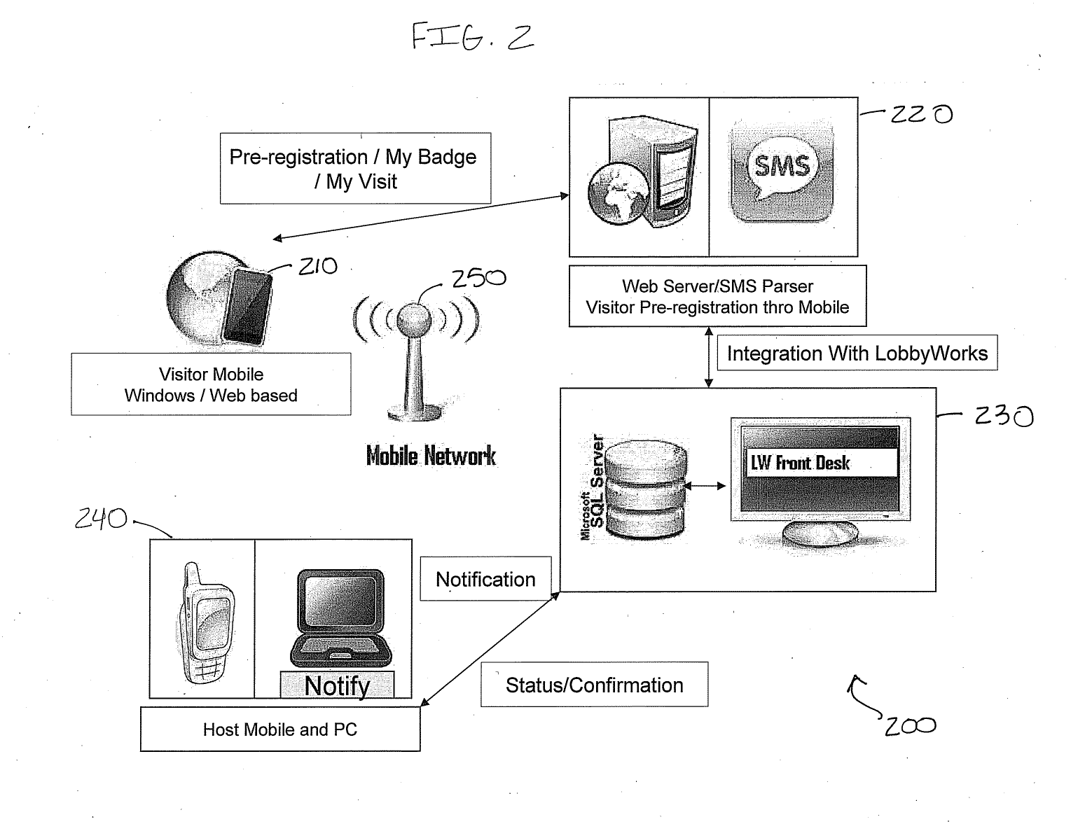

FIG. 2 is a block diagram of a system 200 for carrying out the method of FIG. 1 in accordance with the present invention. The method of FIG. 1 and others in accordance with the present invention can be implemented with the system 200.

As seen in FIG. 2, the system 200 can include a guest mobile device 210, a server or central station 220, a database 230, and a host device 240. In some embodiments, some or all of the guest mobile device 210, the central station 220, the database 230, and the host device 240 can be in wired or wireless communication with one another. For example, in some embodiments, these objects can communicate via a mobile network 250.

The guest mobile device 210 can be Windows® and/or web-based. In some embodiments, the guest mobile device 210 can support and present a user interface for displaying a pre-registration page, an e-badge page, and a page for displaying the guest's past, present, and future appointments. The guest mobile device 210 can communicate with the central station 220.

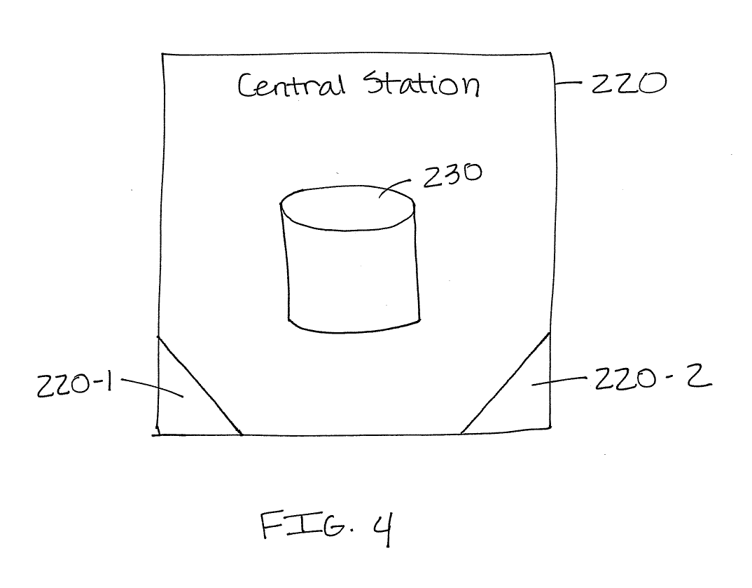

The central station 220 can include a web server and/or an SMS parser. Furthermore, the central station 220 can communicate with the database 230 and can support the pre-registration of a guest prior to an appointment in a building. In some embodiments, the central station 220 and the database 230 can be separate, as seen in FIG. 2, and in some embodiments, the database 230 can be internal to the central station 220, as seen in FIG. 4.

FIG. 4 is a block diagram of a central station 220 in accordance with the present invention. As seen in FIG. 4, the central station can be implemented with one or more programmable processors 220-1 and executable control software 220-2 as would be understood by those of ordinary skill in the art. The executable control software can be stored on a transitory or non-transitory local computer readable medium.

Referring again to FIG. 2, the central station 220 and/or the database 230 can be in communication with a host device 240. For example, the host device 240 can be a mobile device or computer of a host in the building. The central station 220 and/or the database 230 can provide a notification to the host device 240 regarding the guest's pre-registration request. Upon receipt, the host device 240 can authorize or deny a guest's pre-registration request and send a corresponding status update to the central station 220 and/or the database 230.

In embodiments of the present invention, the database 230 can identify a guest's pre-registration request with a status identifier, for example, pending, denied, authorized, or expired.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

From the foregoing, it will be observed that numerous variations and modifications may be effected without departing from the spirit and scope of the invention. It is to be understood that no limitation with respect to the specific system or method illustrated herein is intended or should be inferred. It is, of course, intended to cover by the appended claims all such modifications as fall within the spirit and scope of the claims.

What is claimed is:

1. A method comprising:
receiving a pre-registration request for a future visit to a building;
confirming the pre-registration request; and
providing an e-badge to a guest mobile device for the future visit to the building.

2. The method of claim 1 wherein receiving a pre-registration request for a future visit includes receiving personal information of a guest and receiving information about the future visit to the building.

3. The method of claim 2 wherein the information about the future visit to the building includes a date and duration of the future visit and a host of the future visit.

4. The method of 2 wherein the information about the future visit to the building includes a purpose for the future visit.

5. The method of claim 4 further comprising identifying a host for the future visit based on the purpose for the future visit.

6. The method of claim 1 further comprising storing the pre-registration request in a database and identifying the pre-registration request in the database as pending until the pre-registration request is confirmed.

7. The method of claim 1 wherein confirming the pre-registration request includes submitting the pre-registration request to a host of the future visit for confirmation.

8. The method of claim 1 further comprising storing the pre-registration request in a database and identifying the pre-registration request in the database as authorized after the pre-registration request is confirmed.

9. The method of claim 1 wherein providing an e-badge to a guest mobile device includes displaying the e-badge on the guest mobile device.

10. The method of claim 1 wherein the e-badge includes at least one of a photograph of the guest and a machine-readable representation of data representing information about the guest and the future visit.

11. The method of claim 10 wherein the machine-readable representation of data includes a barcode.

12. The method of claim 1 wherein providing an e-badge to a guest mobile device includes displaying a route map on the guest mobile device, the route map providing directions to the user for traversing the building.

13. The method of claim 1 further comprising removing the e-badge from the guest mobile device after the future visit to the building.

14. The method of claim 1 further comprising storing the pre-registration request in a database and identifying the pre-registration request in the database as expired after the future visit to the building.

15. A non-transitory computer readable medium comprising instructions, which, when implemented by one or more processors, perform the following operations:
displaying pre-registered past, present, and future appointments to visit a building by a user;
receiving input for a pre-registration request;
transmitting a request for confirmation of the pre-registration request;
receiving confirmation for the pre-registration request;
updating the pre-registered past, present, and future appointments based on the received confirmation; and
displaying an e-badge for the pre-registration request.

16. The non-transitory computer readable medium of claim 15 wherein the instructions for displaying an e-badge further include instructions for displaying, on a mobile device of the user, a photograph of the user and instructions for displaying, on a mobile device of the user, a machine-readable representation of data representing information about the user and about the pre-registration request.

17. The non-transitory computer readable medium of claim 15 further comprising instructions for:
receiving input identifying a host for the pre-registration request.

18. The non-transitory computer readable medium of claim 15 further comprising instructions for:
storing the pre-registration request in a database; and
identifying the stored pre-registration request in the database as one of pending, authorized, or expired.

19. The non-transitory computer readable medium of claim 18 further comprising instructions for:
changing an identification of the stored pre-registration request from pending to authorized when a host confirms the pre-registration request.

20. The non-transitory computer readable medium of claim 18 further comprising instructions for:
displaying the e-badge for the pre-registration request only when the pre-registration request is identified as authorized in the database; and
disabling the e-badge for the pre-registration request when the pre-registration request is identified as pending or expired in the database.

21. A system comprising:
executable control software stored on a non-transitory computer readable medium; and
at least one programmable processor for:
receiving a pre-registration request for a future visit to a building;
confirming the pre-registration request; and
providing an e-badge to a guest mobile device for the future visit to the building.
